(19) United States
(12) Patent Application Publication
(10) Pub. No.: US 2012/0103427 A1
(43) Pub. Date: May 3, 2012

(54) MULTIFUNCTIONAL MICROFLUIDIC FLOW CONTROL DEVICE AND MULTIFUNCTIONAL MICROFLUIDIC FLOW CONTROL METHOD

(75) Inventors: Je-Kyun Park, Daejeon (KR); Myung Gwon Lee, Seoul (KR); Sungyoung Choi, Gyeonggi-do (KR)

(73) Assignee: KOREA ADVANCED INSTITUTE OF SCIENCE AND TECHNOLOGY, Daejeon (KR)

(21) Appl. No.: 13/382,728

(22) PCT Filed: Jul. 9, 2010
(86) PCT No.: PCT/KR2010/004477

§ 371 Date: Jan. 6, 2012

(30) Foreign Application Priority Data
Jul. 9, 2009 (KR) 10-2009-0062619

(51) Int. Cl. F15D 1/00

(52) U.S. Cl. 137/3; 137/602

(57) ABSTRACT

Disclosed is a multifunctional microfluidic flow control device. The device includes at least one microfluid injection part, a microfluid channel part and a microfluid discharge part. The microfluid injection part has first and second microfluid injection pathways. The microfluid channel part is connected to the microfluid injection part and has a concavo-convex pattern to control a flow of at least one kind of microfluid injected into the microfluid injection part. The microfluid discharge part is connected to the microfluid channel part so that the microfluid, the flow of which has been controlled, is discharged through the microfluid discharge part.

### TECHNICAL FIELD

The present invention relates, in general, to multifunctional microfluidic flow control devices and multifunctional microfluidic flow control methods and, more particularly, to a multifunctional microfluidic flow control device which makes uses of a microfluidic channel having a concavo-convex pattern and is thus able to realize functions of focusing-, mixing- and separation-controlling microfluid, and a multifunctional microfluidic flow control method using the device.

### BACKGROUND ART

Micro total analysis systems (μ-TASs) refer to small integrated analysis systems which treat, in bulk, processes for analyzing a bio-specimen that include preprocessing (mixing, separating, three-dimensional focusing, etc.) the specimen and detecting the results of the preprocessing.

Recent developments in life science are increasing the number of target substances to be analyzed in fields such as the development of new pharmaceuticals, diagnoses, etc. Therefore, as reagents and specimens that are expensive are needed in quantity, ultramicro analysis is becoming more important as a necessary way to reduce costs. Thereby, the importance of work dealing with reagents or specimens is increasing, so that a lab-on-a-chip technology that integrates a system on a single chip and embodies the system is receiving much attention.

The lab-on-a-chip technology forms a microchannel of several or several tens micrometers in glass, silicone or plastic using the photolithography or micromachining which is widely used in the semiconductor manufacturing field, and makes use of microfluidics that deals with the flow characteristics of a fluid flowing through the formed microchannel, thus controlling a microfluid.

In the conventional microfluidic flow control technology, a specimen preprocessing process, such as focusing, mixing and separating microfluid, is embodied by external force (for example, an electric field, a magnetic field and sound waves) for the purpose of reaction and detection of the specimen that flows through the microchannel. However, the technology that uses the external force and controls microfluid may damage microparticles (for example, cells) contained in the microfluid. Further, separate devices for generating an external force must be configured around a chip. Thus, there are problems of complexity of the chip and a limited reduction in the size thereof.

There has been another microfluidic flow control technology in which a structure is formed in a microchannel and which uses characteristics of microfluidic flow to embody a specimen preprocessing process. However, in this technology, the formation of the structure complicates the microchannel. Also, because this technology can embody only one among functions of focusing, mixing and separating a microfluid, its applicability is low.

### DISCLOSURE

### Technical Problem

Accordingly, the present invention has been made keeping in mind the above problems occurring in the prior art, and an object of the present invention is to provide a multifunctional microfluidic flow control device which makes use of a microfluid channel part having a concavo-convex pattern that includes a plurality of first-channel sections and a plurality of second-channel sections which alternate with the first-channel sections and each of which has a microfluidic flow cross-section area that is smaller than that of each first-channel section, so that a secondary flow is formed in the microfluid channel part, thus making it possible to focusing-, mixing- and separating-control microfluid, and a multifunctional microfluidic flow control method using the device.

### Technical Solution

In order to accomplish the above object, in an aspect, the present invention provides a multifunctional microfluidic flow control device, including at least one microfluid injection part having first and second microfluid injection pathways, a microfluid channel part connected to the microfluid injection part, the microfluid channel part having a concavo-convex pattern to control a flow of at least one kind of microfluid injected into the microfluid injection part, and a microfluid discharge part connected to the microfluid channel part so that the microfluid, the flow of which has been controlled, is discharged through the microfluid discharge part.

The concavo-convex pattern of the microfluid channel part may include a plurality of first-channel sections, and a plurality of second-channel sections alternating with the first-channel sections, each of the second-channel sections having a smaller microfluidic flow cross-sectional area than each of the first-channel sections.

The microfluid may form a primary flow in each of the first-channel sections in a direction of progression towards the microfluid discharge part. The microfluid may form a secondary flow crossing the primary flow in each of the second-channel sections. The secondary flow may form upward and downward eddies crossing the primary flow of the microfluid flowing through the second-channel section.

When a first microfluid is injected into the first microfluid injection pathway and a second microfluid differing from the first microfluid is injected into the second microfluid injection pathway, the second-channel sections may control the first and second microfluids such that the second microfluid surrounds the first microfluid due to the eddies so that the first microfluid is focused on a central portion.

The second-channel sections may control the first and second microfluids such that after the second microfluid has surrounded the first microfluid and the first microfluid has been focused on the central portion, when the first and second microfluids pass through at least one more second-channel section, the first and second microfluids are mixed with each other by the eddies.

When a first microfluid containing different sizes of particles is injected into the first microfluid injection pathway and a second microfluid is injected into the second microfluid injection pathway, the second-channel sections may control the first and second microfluids such that the different sizes of particles are separated from each other by size by the eddies.

In the concavo-convex pattern, each of the first-channel sections or each of the first-channel sections may have a shape of one among a sawtooth, a semicircle and a rectangle.

In another aspect, the present invention provides a multifunctional microfluidic flow control method, including a first step of injecting at least one kind of microfluid into at least one microfluid injection part having first and second microfluid injection pathways, a second step of controlling a flow of the microfluid through a microfluid channel part having a concavo-convex pattern, the microfluid channel part being connected to the microfluid injection part, and a third step of discharging the microfluid, the flow of which has been controlled, through a microfluid discharge part connected to the microfluid channel part.

The second step may include controlling the flow of the microfluid using a plurality of first-channel sections and a plurality of second-channel sections of the concavo-convex pattern, the second-channel sections alternating with the first-channel sections and each having a smaller microfluidic flow cross-sectional area than each of the first-channel sections.

The microfluid may form a primary flow in each of the first-channel sections in a direction of progression towards the microfluid discharge part. The microfluid may form a secondary flow crossing the primary flow in each of the second-channel sections. The secondary flow may form upward and downward eddies crossing the primary flow of the microfluid flowing through the second-channel section.

The second step may include, when a first microfluid is injected into the first microfluid injection pathway and a second microfluid differing from the first microfluid is injected into the second microfluid injection pathway, controlling the first and second microfluids such that the second microfluid surrounds the first microfluid due to the eddies so that the first microfluid is focused on a central portion.

The second step may include controlling the first and second microfluids such that after the second microfluid has surrounded the first microfluid and the first microfluid has been focused on the central portion, when the first and second microfluids pass through at least one more second-channel section, the first and second microfluids are mixed with each other by the eddies.

The second step may include, when a first microfluid containing different sizes of particles is injected into the first microfluid injection pathway and a second microfluid is injected into the second microfluid injection pathway, controlling the first and second microfluids such that the different sizes of particles are separated from each other by size by the eddies.

In the concavo-convex pattern, each of the first-channel sections or each of the first-channel sections may have a shape of one among a sawtooth, a semicircle and a rectangle.

### Advantageous Effects

In a microfluidic flow control device of the present invention, a concavo-convex pattern is configured such that microfluid channel parts having different microfluidic flow cross-sectional areas are formed in each channel section so that eddies are formed by secondary flow and a lift force is generated, thus making it possible to do focusing-, mixing- and separating-control on microfluid without using an external force (for example, an electric field, a magnetic field or sound waves).

Therefore, the present invention does not require separate devices for generating external force around the microfluidic flow control device. Thus, the device can be simplified, and its size can be reduced. Furthermore, the microfluidic flow control device can do focusing-, mixing- and separating-control on the microfluid, thus realizing multifunctional purposes. Thereby, the applicability of the device can be enhanced.

### DESCRIPTION OF DRAWINGS

FIG. 1 is a view illustrating a multifunctional microfluidic flow control device, according to an embodiment of the present invention;

FIG. 2 is a view illustrating a focusing control function of the multifunctional microfluidic flow control device of FIG. 1;

FIGS. 3 and 4 are views showing forms of a microfluidic flow in a cross-section of the multifunctional microfluidic flow control device of FIG. 2;

FIG. 5 is a view illustrating a mixing control function of the multifunctional microfluidic flow control device of FIG. 1;

FIG. 6 is a view showing a form of microfluidic flow in the multifunctional microfluidic flow control device of FIG. 5;

FIG. 7 is a graph showing microfluid mixing efficiencies in the multifunctional microfluidic flow control device of FIG. 5;

FIGS. 8 and 9 are respectively views showing a multifunctional microfluidic flow control device and forms of microfluidic flow therein, according to the embodiment of the present invention;

FIG. 10 is a view illustrating a separation control function of the multifunctional microfluidic flow control device of FIG. 1; and

FIG. 11 is a view showing a form of microfluidic flow in the multifunctional microfluidic flow control device of FIG. 10.

### DESCRIPTION OF THE REFERENCE NUMERALS IN THE DRAWINGS

100: microfluidic flow control device
110: microfluid injection part
111: first microfluid injection pathway
113: second microfluid injection pathway
130: microfluid channel part
131: first-channel section
133: second-channel section
140: microfluid discharge part

### BEST MODE

Hereinafter, the present invention will be described in detail with reference to the attached drawings.

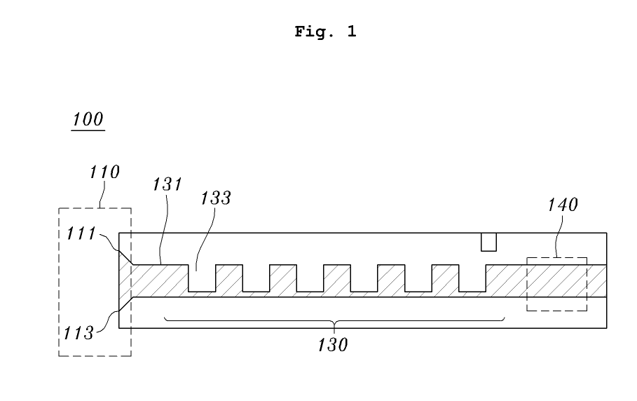

FIG. 1 is a view illustrating a multifunctional microfluidic flow control device, according to an embodiment of the present invention. Referring to FIG. 1, the multifunctional microfluidic flow control device 100 includes a microfluid injection part 110, a microfluid channel part 130 and a microfluid discharge part 140.

The microfluid injection part 110 is a part into which at least one kind of microfluid is injected. In this embodiment, the microfluid injection part 110 includes a first microfluid injection pathway 111 and a second microfluid injection pathway 113. In this case, the same kind of microfluid or different kinds of first and second microfluids may be respectively injected into the first microfluid injection pathway 111 and the second microfluid injection pathway 113. Furthermore, although the microfluid injection part 110 is illustrated in the drawing as having the two pathways 111 and 113, the microfluid injection part 110 may have three or more pathways.

The microfluid channel part 130 is connected to the microfluid injection part 110 and functions as a fluid channel which allows one or more kinds of microfluid injected through the microfluid injection part 110 to flow in one direction. Further, the microfluid channel part 130 controls the microfluids, which are flowing therethrough, so that the microfluids are focused or mixed with each other or different sizes of particles contained in the microfluids are separated from each other. The microfluids which have been controlled to be focused, mixed or separated are discharged to the outside through the microfluid discharge part 140.

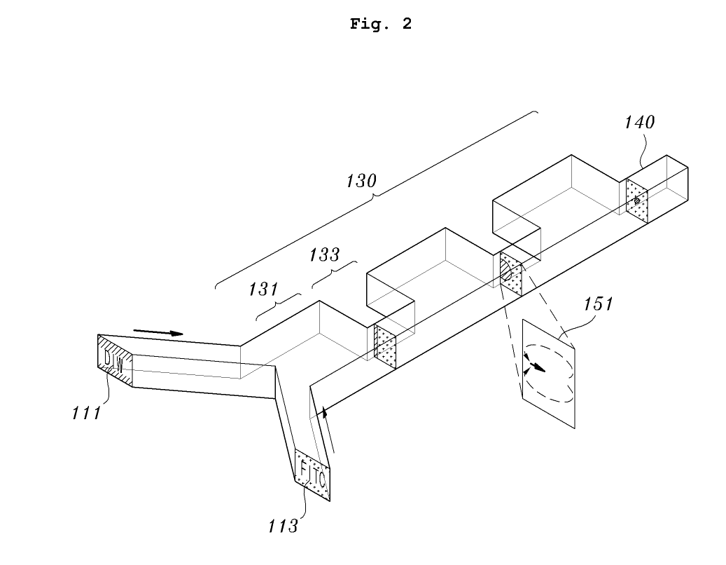

FIG. 2 is a view illustrating a focusing control function of the multifunctional microfluidic flow control device of FIG. 1. Referring to FIG. 2, the microfluid channel part 130 is formed in a concavo-convex pattern. In this case, the concavo-convex pattern includes a plurality of first-channel sections 131 and a plurality of second-channel sections 133.

In the concavo-convex pattern, the second-channel sections 133 alternate with the first-channel sections 131, and a flow cross-sectional area of a microfluid in each second-channel section 133 is less than that in each first-channel section 131. In addition, the lengths, widths and heights of each first-channel section 131 and each second-channel section 133 may be set differently in predetermined dimensions (for example, 30 μm, 50 μm, 100 μm, 300 μm, 600 μm, 900 μm).

In the drawings, although each first-channel section 131 and each second-channel section 133 are illustrated as having rectangular shapes, each first-channel section 131 or each second-channel section 133 may have the shape of a sawtooth or semicircle.

When the first microfluid (for example, water-DIW) and the second microfluid (for example, fluorescent agent-FITC) are respectively injected into the first microfluid injection pathway 111 and the second microfluid injection pathway 113 and flow through the first-channel section 131, a primary flow is formed in a direction of progression towards the microfluid discharge part 140. When the first and second microfluids which have passed through the first-channel section 131 flow through the second-channel section 133, a flow cross-sectional area difference between the first-channel section 131 and the second-channel section 133 creates a secondary flow (151, a dean flow) which is oriented in a direction crossing the primary flow. As shown in FIG. 2, the secondary flow 151 forms upward and downward eddies in the direction crossing the primary flow. The eddies rotate the first microfluid upwards and downwards so that the first microfluid is focused on the center while the second microfluid is disposed around the vicinity of the first microfluid. Thus, the flow is controlled in such a way that the first microfluid is focused on the center, before the first and second microfluids are discharged to the outside through the microfluid discharge part 140. In this case, the first microfluid can be focused in a three-dimensional form in which the second microfluid surrounds the first microfluid, before being discharged to the outside.

In the present invention, when the first microfluid and the second microfluid are injected into the microfluidic flow control device, either the first microfluid or the second microfluid can be focused. In FIG. 2, the object to be focused by the second flow is the first microfluid. The object to be focused can be determined depending on the structure of the microfluidic flow control device 100 shown in FIG. 2. In detail, due to the structure in which the second-channel sections 133, of which the flow cross-sectional areas are less than those of the first-channel sections 131, are biased to only one side of the microfluid channel part 130, the first microfluid which is injected from the side adjacent to the second-channel section 133 is focused. If the object to be focused would be the second microfluid in the flow control device 100 of FIG. 2, the second microfluid must be injected into the first microfluid injection pathway 111 while the first microfluid is injected into the second microfluid injection pathway 113. Otherwise, another microfluidic flow control device must be used, in which the second-channel sections 133 are biased to the side opposite that of the microfluid channel part 130 of FIG. 2, that is, at the side adjacent to the second microfluid injection pathway 113, so that the second microfluid can be focused.

As stated above, to form the secondary flow, the first-channel sections 131 and the second-channel sections 133 have different flow cross-sectional areas. In the embodiment of FIG. 2, each first-channel section 131 has a width of 350 μm and a height of 38 μm, and each second-channel section 133 has a width 50 μm and a height of 38 μm so that the flow cross-sectional area of the second-channel section 133 is smaller than that of the first-channel section 131. In this case, a ratio of the flow cross-sectional area of the first-channel section 131 to that of the second-channel section 133 is 7:1.

In the present invention, the ratio of the flow cross-sectional area of the first-channel section 131 to that of the second-channel section 133 is not limited to 7:1, and it may be modified in a variety of ways in consideration of the characteristics of the microfluid, such as flow rate, viscosity, etc.

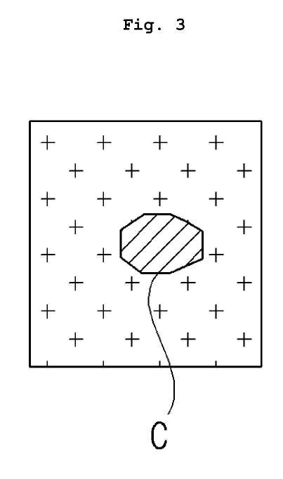

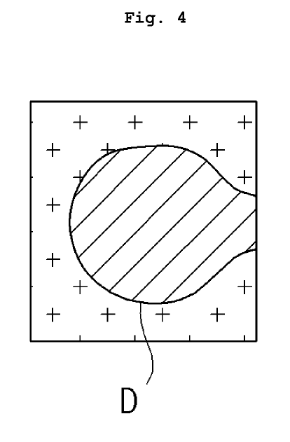

FIGS. 3 and 4 are views showing forms of the microfluidic flow in a cross-section of the multifunctional microfluidic flow control device of FIG. 2. In detail, FIGS. 3 and 4 illustrate the cross-section of the third second-channel section 133 of FIG. 2 in which the first microfluid is focused on the center, showing the focusing size of the first microfluid depending on a ratio of the flow rate of the first microfluid to that of the second microfluid.

FIG. 3 shows the focusing size of the first microfluid when a ratio of the flow rate of the first microfluid (for example, water) injected into the first microfluid injection pathway 111 to that of the second microfluid (for example, fluorescent agent) injected into the second microfluid injection pathway 113 is 1:10. FIG. 4 shows the focusing size when the ratio of the flow rates is 1:1.

Comparing FIGS. 3 and 4, the size C of the first microfluid when the ratio of the flow rates is 1:10 is smaller than the size D of the first microfluid when the ratio of the flow rates is 1:1. It can be understood that the case of FIG. 3 can be more effectively focused than that of FIG. 4. In other words, the less the flow rate of the first microfluid is than that of the second microfluid, the larger the focusing effect of the first microfluid.

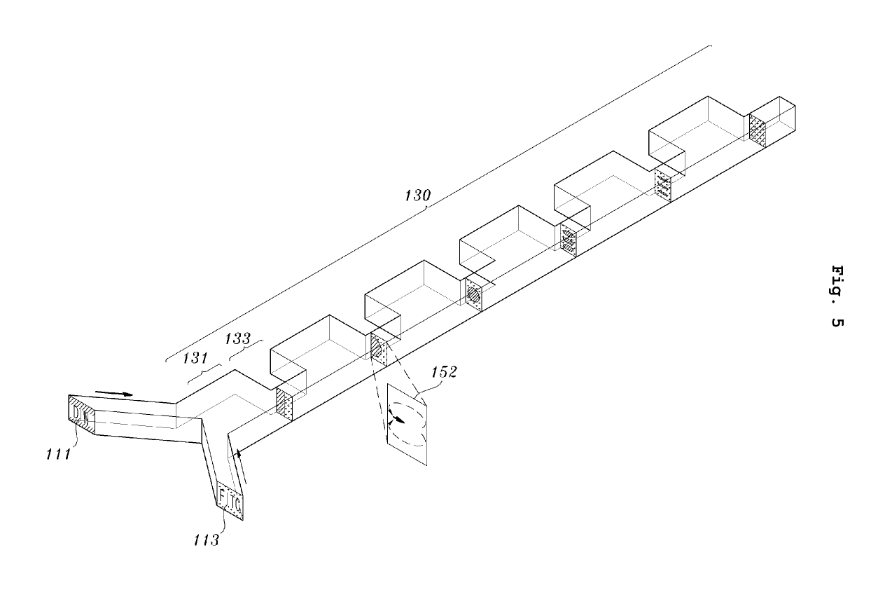

FIG. 5 is a view illustrating a mixing control function of the multifunctional microfluidic flow control device of FIG. 1. The multifunctional microfluidic flow control device shown in FIG. 5 has the same construction as that shown in FIG. 1.

Therefore, the explanation of the same construction and function of the device FIG. 5 as that of FIG. 1 will be omitted.

In the multifunctional microfluidic flow control device of FIG. 5, the number of alternations of first-channel sections 131 and second-channel sections 133 is greater than that of the device shown in FIG. 2. Referring to the drawings, in the microfluidic flow control device of FIG. 2 having the focusing control function, the first-channel section 131 and the second-channel sections 133 alternate three times. On the other hand, in the microfluidic flow control device of FIG. 5 having the focusing control function, they alternate six times. An increase in the number of alternations of the first-channel sections 131 and the second-channel sections 133 enables the microfluidic flow control device of FIG. 5 to control the mixing of the first microfluid and the second microfluid with each other.

In detail, in the microfluid channel part 130 of FIG. 5, until microfluids flow to the second-channel section 133 that is disposed at a third position of the concavo-convex pattern, the first microfluid is focused in the same manner as that of FIG. 2. Subsequently, however, when the first microfluid and the second microfluid pass through the second-channel section 133 that is disposed at a fourth position of the concavo-convex pattern, a secondary flow 152 is created in the fourth second-channel section 133. The secondary flow 152 forms upward and downward eddies so that the first microfluid and the second microfluid are separated from each other and layered. When the first microfluid and the second microfluid pass through the second-channel section 133 that is disposed at a fifth position, the first microfluid and the second microfluid form a larger number layers. Thereafter, when the first microfluid and the second microfluid pass through the second-channel section 133 that is disposed at a sixth position of the concavo-convex pattern, there is a phenomenon in which the first microfluid and the second microfluid are mixed with each other in a lot of fine layers. The first microfluid and the second microfluid that have been mixed with each other in the above-mentioned manner are discharged to the outside through the microfluid discharge part 140.

As such, as the microfluid channel part 130 is designed such that the first microfluid and the second microfluid pass through an increased number of second-channel sections 133, it can control the first microfluid and the second microfluid so that they are appropriately mixed with each other.

In the present invention, with regard to the flow of the first microfluid and the second microfluid, the number of alternations of the first-channel sections 131 and the second-channel sections 133 for focusing- or mixing-control may be changed depending on the flow rate of the first microfluid and the second microfluid.

In detail, in FIG. 2, although the first-channel sections 131 and the second-channel sections 133 have been illustrated as alternating three times, the number of alternations of the first-channel sections 131 and the second-channel sections 133 for focusing may be changed depending on the flow rate of the first microfluid and the second microfluid. In other words, if the flow rate of the first microfluid and the second microfluid that are injected is 5.5 ml/h, either the first microfluid or the second microfluid can be focused on the center in the third second-channel section 133. If the flow rate of the first and second microfluids becomes higher than 5.5 ml/h, the focusing may emerge in a second-channel section 133 after the third second-channel section 133. Depending on the flow rate of the first microfluid and the second microfluid, the focusing may emerge in the fourth second-channel section 133 or the fifth second-channel section 133. On the other hand, if the flow rate of the first microfluid and the second microfluid drops below 5.5 ml/h, the focusing may emerge in a second-channel section 133 before the third second-channel section 133. This can be applied to the microfluidic flow control device shown in FIG. 5 in the same manner.

In other words, in the device of FIG. 5, if the flow rate of the first and second microfluids that are injected is 5.5 ml/h, the first and second microfluids can be mixed with each other in the sixth second-channel section 133. If the flow rate of the first microfluid and the second microfluid that are injected is higher than 5.5 ml/h, the first microfluid and the second microfluid may be mixed with each other after the sixth second-channel section 133. If the flow rate is less than 5.5 ml/h, they may be mixed with each other before the sixth second-channel section 133.

Therefore, the device for focusing-control and the device for mixing-control can be designed in consideration of the flow rate of the first and second microfluids. Alternatively, although a single device is used, it may be configured such that the flow rate at which the first microfluid and the second microfluid are injected into the device is differently adjusted when focusing-controlling and mixing-controlling.

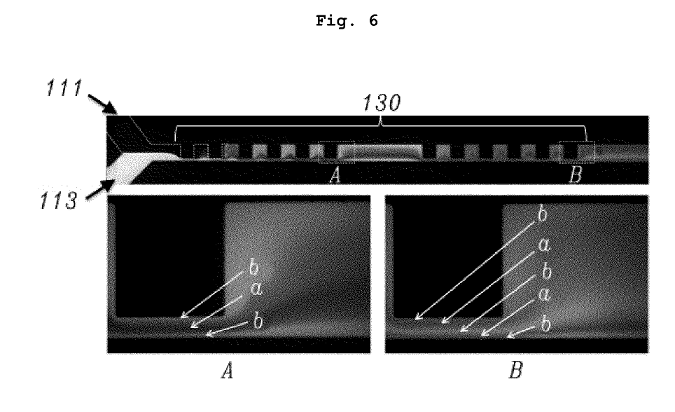

FIG. 6 is a view showing a form of microfluidic flow in the multifunctional microfluidic flow control device of FIG. 5. In detail, FIG. 6 illustrates a form, in which after two different kinds of first and second microfluids, that is, water (a:DIW) and fluorescent agent (b:FITC), are respectively injected to the microfluid injection pathway 111 and the second microfluid injection pathway 113 at the same flow rate, the water a and the fluorescent agent b are mixing-controlled in the microfluid channel part 130.

When water a and fluorescent agent b flows through the first-channel section 131 after having respectively passed through the first microfluid injection pathway 111 and the second microfluid injection pathway 113, the water a and the fluorescent agent b form a primary flow in a direction in which they move towards the microfluid discharge part 140. Thereafter, while the water a and the fluorescent agent b pass through the second-channel section 133 of which the flow cross-sectional area is smaller than that of the first-channel section 131, a secondary flow is formed in a direction crossing the primary flow. The secondary flow forms upward and downward eddies in the direction crossing the primary flow. Due to these eddies, the fluorescent agent b surrounds the water a. While the water a and the fluorescent agent b successively pass through the remaining first-channel sections 131 and second-channel sections 133, they are layered.

Referring to FIG. 6, while water a and fluorescent agent b which are respectively injected into the first microfluid injection pathway 111 and the second microfluid injection pathway 113 pass through the microfluid channel part 130, the closer they to the microfluid discharge part 140, the higher the mixing efficiency.

Referring to the enlarged views of the areas A and B of the microfluid channel part 130, it is appreciated that water a and fluorescent agent b are layered in a manner of b-a-b in the area A. In the area B that is closer to the microfluid discharge part 140 than the area A, the water a and the fluorescent agent b are layered in a manner of b-a-b-a-b. As such, the closer the water a and the fluorescent agent b are to the microfluid discharge part 140, that is, the more number of first-channel sections 131 and second-channel sections 133 they pass through, the greater is the number of layers formed by the water a and the fluorescent agent b. Hence, the surface contact rate between the water a and the fluorescent agent b increases, so that the mixing efficiency increases.

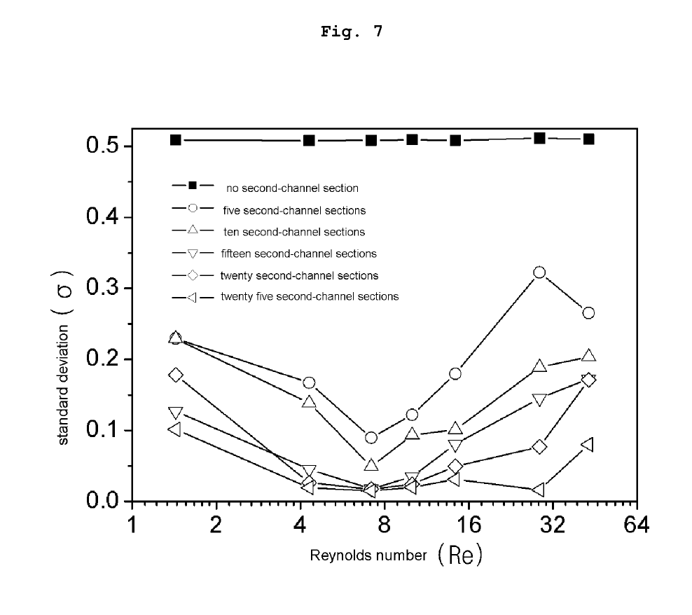

FIG. 7 is a graph showing microfluid mixing efficiencies in the multifunctional microfluidic flow control device according to the embodiment of the present invention. In detail, FIG. 7 shows the microfluid mixing efficiency of the conventional microfluidic flow control device having no concavo-convex pattern with first-channel sections and second-channel sections, and the microfluid mixing efficiency of the microfluidic flow control device according to the embodiment of the present invention. Furthermore, this drawing shows the microfluid mixing efficiencies of several examples having different second-channel sections in the microfluidic flow control device according to the embodiment of the present invention.

In the graph of FIG. 7, the x-axis denotes the Reynolds number (Re=Vd/v, V=flow rate, d=characteristic length, v=kinematic viscosity), and the y-axis denotes the standard deviation (σ) of the intensity of fluorescence according to the number of second-channel sections 133 through which water and fluorescent agent have passed. It is represented such that as the standard deviation (σ) becomes close to 0.5, the rate at which water and fluorescent agent are mixed with each other is reduced, and as the standard deviation (σ) becomes close to 0, the mixing rate is increased.

Referring to FIG. 7, in the conventional microfluidic flow control device (▪) which is provided with the microfluid channel part having a constant flow cross-sectional area without distinction between a first-channel section and a second-channel section, the standard deviation was 0.5 within a Reynolds number range from 1 to 64. It can be understood that the water and the fluorescent agent mix a little with each other.

In the embodiment of the present invention, in the case (∘) of the microfluidic flow control device having five second-channel sections, the standard deviation was between about 0.08 and about 0.35 when the Reynolds number was in the range of from 1 to 64. It can be appreciated that the efficiency with which the water and the fluorescent agent are mixed is improved, compared to that of the conventional case having no second-channel section.

In the case (Δ) of the microfluidic flow control device having ten second-channel sections, in the case (∇) of having fifteen second-channel sections, and in the case (⋄) of having twenty second-channel sections, the standard deviations were between about 0.03 and about 2.4 within the Reynolds number range from 1 to 64.

Particularly, in the case ( [symbol] ) of having twenty five second-channel sections, the standard deviation was between about 0.02 and about 0.1 within a Reynolds number range of from 1 to 64. It can be interpreted that the efficiency with which the water and the fluorescent agent are mixed is superior. As such, it is to be understood that increasing the number of second-channel sections which form secondary flows of microfluid can enhance the microfluid mixing efficiency.

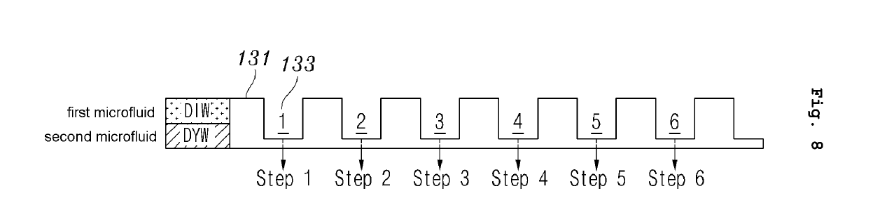

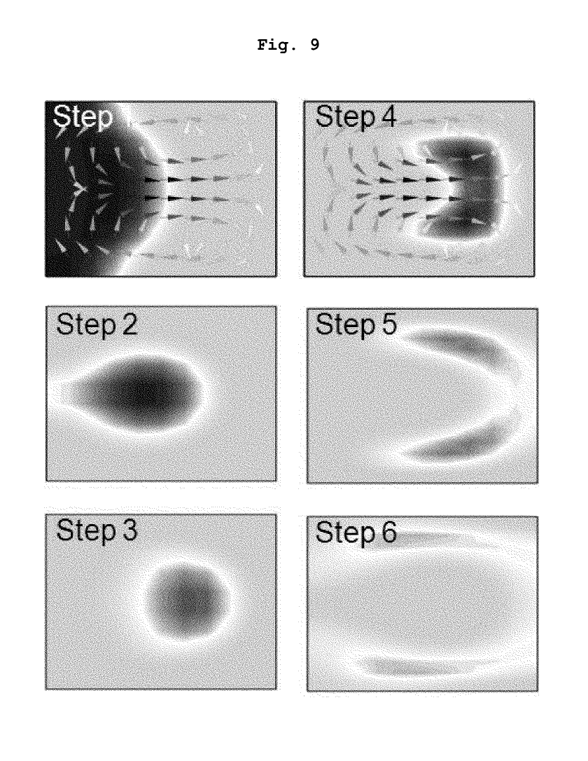

FIGS. 8 and 9 are respectively views showing a multifunctional microfluidic flow control device and forms of microfluidic flow therein, according to an embodiment of the present invention.

Referring to FIG. 8, the microfluidic flow control device includes a microfluid channel part in which the first-channel sections and the second-channel sections alternate six times. FIG. 9 illustrates the forms of microfluidic flow at points 1 through 6 of second channel sections in which secondary flows emerge, on the assumption that a first microfluid (for example, water) and a second microfluid (for example, fluorescent agent) are injected into the device of FIG. 8. In FIG. 9, the forms of microfluidic flow at the points are indicated by unit steps.

Referring to FIG. 9, in the form (step 1) of microfluidic flow at the point 1, as indicated in the directions of the arrows, it can be appreciated that upward and downwards eddies are formed in the cross-sectional direction of the point 1. It can be confirmed that the first microfluid is partially displaced into the area of the second microfluid by such eddies. In the form (step 2) of microfluidic flow at the point 2, a large amount of the first microfluid is moved into the area of the second microfluid so that the second microfluid surrounds the first microfluid. This is formed by the phenomenon in which the eddies focus the first microfluid on the center.

In the form (step 3) of microfluidic flow at the point 3, the second microfluid completely surrounds the first microfluid so that the first microfluid is completely focused at the center.

Thereafter, in the form (step 4) of microfluidic flow at the point 4, upward and downward eddies are formed, so that the first microfluid which has been focused at the point 3 is partially deformed. In the form (step 5) of microfluidic flow at the point 5, the first microfluid begins to be divided into upper and lower parts and layered. In the form (step 6) of microfluidic flow at the point 6, the first microfluid is divided into two parts and completely layered. If the first and second microfluids pass through a larger number of first-channel sections and second-channel sections, the first microfluid and the second microfluid form a larger number of layers so that they form a mixed shape.

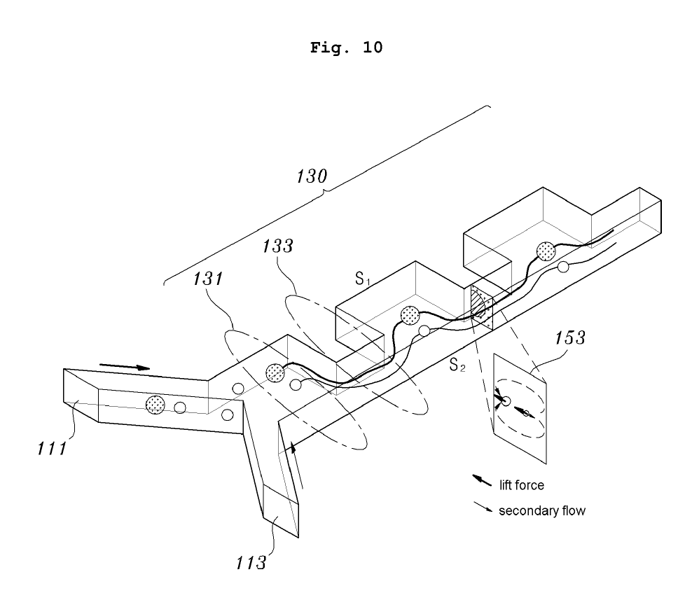

FIG. 10 is a view illustrating the separation control function of the multifunctional microfluidic flow control device shown in FIG. 1. The multifunctional microfluidic flow control device depicted in FIG. 10 has the same construction as that shown in FIG. 1. Therefore, the explanation of the same construction and function of the device in FIG. 10, which is similar to that of FIG. 1, will be omitted.

A first microfluid containing different sized particles is injected into the first microfluid injection pathway 111, while a second microfluid containing no particles is injected into the second microfluid injection pathway 113. Then, the microfluid channel part 130 separates the particles by size before they are discharged through the microfluid discharge part 140. In detail, when a first microfluid containing different sized particles, for example, beads of 4 μm and beads of 10 μm, is injected into the first microfluid injection pathway 111, the first microfluid, along with a second microfluid which has been injected into the second microfluid injection pathway 113, passes through the microfluid channel part 130. Here, the kind of the first microfluid may be different from that of the second microfluid, and they are preferably of the same kind of material.

During this process, when the first and second microfluids pass through the second-channel section 133 of the microfluid channel part 130, an inertial lift force and a secondary flow (a dean flow) 153 are generated because the flow cross-sectional area of the second-channel section 133 is smaller than that of the first-channel section 131. The inertial lift force and the secondary flow 153, which forms upward and downward eddies on the cross-section of the second-channel section, separate the particles contained in the first microfluid from each other by size. That is, between the force generated by the secondary flow and the inertial lift force generated in the second-channel section 133, the balance of force which mainly affects the particles is different depending on the sizes of the particles. Therefore, the particles contained in the first microfluid can be separated from each other. For instance, the inertial lift force mainly affects particles of a comparatively large size (for example, 7 μm or more) so that the large particles are biased to a first side S₁ of the second-channel section 133. On the other hand, the secondary flow (dean flow) mainly affects particles of a comparatively small size (for example, 7 μm or less, including nanometer particles) so that the small particles are biased to a second side S₂ of the second-channel section 133. The inertial lift force that affects the comparatively large particles depends on the exposure time it takes for the particles to pass through the second-channel section 133. For example, comparing the length of the second-channel section 133 which is 300 μm to when it is 900 μm, on the assumption that particles of the same size (for instance, 10 μm) pass through the second-channel section 133, when the large particles pass through a second-channel section that is 900 μm in length, the exposure time for which the inertial lift force can affect the large particles is longer than that of a second-channel section that is 300 μm in length. Therefore, in the case of the second-channel section of 900 μm in length, the large particles move closer to the first side S₁ of the second-channel section 133. When the large particles pass through the second-channel section that is 300 μm in length, the exposure time for which the inertial lift force can affect the large particles is shorter than that of the second-channel section that is 900 μm long. Thus, the large particles are not as close to the first side S₁ of the second-channel section 133 as when passing through the second-channel section that is 900 μm long. As such, the particles contained in the microfluid can be separated by size and discharged to the outside through the microfluid discharge part 140.

Furthermore, as shown in FIG. 10, the microfluid discharge part 140 may include two discharge pathways so that the particles that have been separated by size can be more easily discharged to the outside.

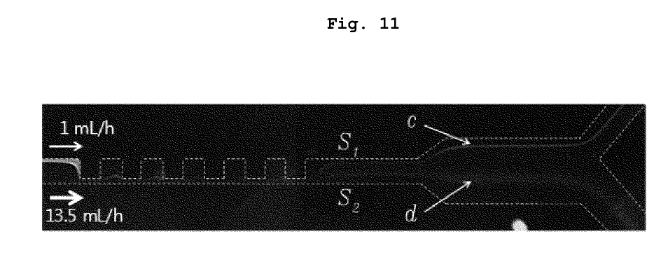

FIG. 11 is a view showing the form of microfluidic flow in the multifunctional microfluidic flow control device of FIG. 10. As shown in FIG. 11, a first microfluid (for example, water) containing different sizes of particles c and d is injected into the first microfluid injection part 111 at a flow rate of 0.5 ml/h, while a second microfluid (for example, water) is injected into the second microfluid injection part 113 at a flow rate of 5 ml/h. The drawing illustrates the form in which the microfluids pass through the microfluid channel part 130 before being discharged to the outside.

While first particles c that are 10 μm in size and second particles d of 4 μm in size pass through the several second-channel sections 133, the first particles c are moved to the first side S₁ by the secondary flows, and the second particles d are moved to the second side S₂ so that the particles become separated by size. If the flow rate of the first microfluid containing the first particles c and the second particles d and the flow rate of the second microfluid are changed, the position at which the first particles c are separated from the second particles d can be varied. For example, the less the flow rate of the first microfluid containing the first particles c and the second particles d than that of the second microfluid, the greater the increase in the efficiency with which the first particles c are separated from the second particle d.

Further, changing the length of the second-channel section 133 can adjust the exposure time for which the inertial lift force has an affect on the first particles c and the second particles, thus making it possible to vary the position at which the first particles c are separated from the second particles d. Moreover, making use of these can increase the efficiency of separating the particles.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A multifunctional microfluidic flow control device, comprising:
at least one microfluid injection part having first and second microfluid injection pathways;
a microfluid channel part connected to the microfluid injection part, the microfluid channel part having a concavo-convex pattern to control a flow of at least one kind of microfluid injected into the microfluid injection part; and
a microfluid discharge part connected to the microfluid channel part so that the microfluid, the flow of which has been controlled, is discharged through the microfluid discharge part.

2. The multifunctional microfluidic flow control device according to claim 1, wherein the concavo-convex pattern of the microfluid channel part comprises:
a plurality of first-channel sections; and
a plurality of second-channel sections alternating with the first-channel sections, each of the second-channel sections having a smaller microfluidic flow cross-sectional area than each of the first-channel sections.

3. The multifunctional microfluidic flow control device according to claim 2, wherein the microfluid forms a primary flow in each of the first-channel sections in a direction of progression towards the microfluid discharge part.

4. The multifunctional microfluidic flow control device according to claim 3, wherein the microfluid forms a secondary flow crossing the primary flow in each of the second-channel sections.

5. The multifunctional microfluidic flow control device according to claim 4, wherein the secondary flow forms upward and downward eddies crossing the primary flow of the microfluid flowing through the second-channel section.

6. The multifunctional microfluidic flow control device according to claim 5, wherein when a first microfluid is injected into the first microfluid injection pathway and a second microfluid differing from the first microfluid is injected into the second microfluid injection pathway, the second-channel sections control the first and second microfluids such that the second microfluid surrounds the first microfluid due to the eddies so that the first microfluid is focused on a central portion.

7. The multifunctional microfluidic flow control device according to claim 6, wherein the second-channel sections control the first and second microfluids such that after the second microfluid has surrounded the first microfluid and the first microfluid has been focused on the central portion, when the first and second microfluids pass through at least one more second-channel section, the first and second microfluids are mixed with each other by the eddies.

8. The multifunctional microfluidic flow control device according to claim 5, wherein when a first microfluid containing different sizes of particles is injected into the first microfluid injection pathway and a second microfluid is injected into the second microfluid injection pathway, the second-channel sections control the first and second microfluids such that the different sizes of particles are separated from each other by size by the eddies.

9. The multifunctional microfluidic flow control device according to claim 2, wherein in the concavo-convex pattern, each of the first-channel sections or each of the first-channel sections has a shape of one among a sawtooth, a semicircle and a rectangle.

10. A multifunctional microfluidic flow control method, comprising:
a first step of injecting at least one kind of microfluid into at least one microfluid injection part having first and second microfluid injection pathways;
a second step of controlling a flow of the microfluid through a microfluid channel part having a concavo-convex pattern, the microfluid channel part being connected to the microfluid injection part; and
a third step of discharging the microfluid, the flow of which has been controlled, through a microfluid discharge part connected to the microfluid channel part.

11. The multifunctional microfluidic flow control method according to claim 10, wherein the second step comprises
controlling the flow of the microfluid using a plurality of first-channel sections and a plurality of second-channel sections of the concavo-convex pattern, the second-channel sections alternating with the first-channel sections and each having a smaller microfluidic flow cross-sectional area than each of the first-channel sections.

12. The multifunctional microfluidic flow control method according to claim 11, wherein the microfluid forms a primary flow in each of the first-channel sections in a direction of progression towards the microfluid discharge part.

13. The multifunctional microfluidic flow control method according to claim 12, wherein the microfluid forms a secondary flow crossing the primary flow in each of the second-channel sections.

14. The multifunctional microfluidic flow control method according to claim 13, wherein the secondary flow forms upward and downward eddies crossing the primary flow of the microfluid flowing through the second-channel section.

15. The multifunctional microfluidic flow control method according to claim 14, wherein the second step comprises, when a first microfluid is injected into the first microfluid injection pathway and a second microfluid differing from the first microfluid is injected into the second microfluid injection pathway,
controlling the first and second microfluids such that the second microfluid surrounds the first microfluid due to the eddies so that the first microfluid is focused on a central portion.

16. The multifunctional microfluidic flow control method according to claim 15, wherein the second step comprises
controlling the first and second microfluids such that after the second microfluid has surrounded the first microfluid and the first microfluid has been focused on the central portion, when the first and second microfluids pass through at least one more second-channel section, the first and second microfluids are mixed with each other by the eddies.

17. The multifunctional microfluidic flow control method according to claim 14, wherein the second step comprises, when a first microfluid containing different sizes of particles is injected into the first microfluid injection pathway and a second microfluid is injected into the second microfluid injection pathway,
controlling the first and second microfluids such that the different sizes of particles are separated from each other by size by the eddies.

18. The multifunctional microfluidic flow control method according to claim 11, wherein in the concavo-convex pattern, each of the first-channel sections or each of the first-channel sections has a shape of one among a sawtooth, a semicircle and a rectangle.

19. The multifunctional microfluidic flow control method according to claim 11, further comprising:
controlling an exposure time for which the microfluid passes through the first-channel sections and the second-channel sections.
